(19) United States
(12) Patent Application Publication
(10) Pub. No.: US 2016/0176250 A1
(43) Pub. Date: Jun. 23, 2016

(54) RUBBER INLAY CLAW

(71) Applicant: Zong Hai, YingKou (CN)

(72) Inventor: Zong Hai, YingKou (CN)

(21) Appl. No.: 14/730,825

(22) Filed: Jun. 4, 2015

(30) Foreign Application Priority Data
Dec. 18, 2014 (CN) 201410781562.4

(51) Int. Cl. B60C 25/05

(52) U.S. Cl. CPC B60C 25/0539

(57) ABSTRACT

Rubber inlay claw is for rim installation with a tire changer. It consists of a: steel claw base, rubber clamp protection pad, nylon pad and M4 countersunk screw. The dovetail boss of the rubber clamp protection pad is inserted into the dovetail groove of the steel claw, while the two cylindrical bosses of the nylon pad are situated into the two holes of the steel claw, and the M4 countersunk screw is used to fasten the nylon pad to the steel claw; it also secures the rubber clamp protection pad, prevents it from sliding upward off of the steel claw, forming rubber inlay claw. The claw addresses the risk of damaging the aluminum rims when they are dismantled or installed. It also ensures tight gripping and fixation of the tires. Moreover, it has a simple structure with easy installation and low cost, while provides a very reliable and practical value.

### CROSS-REFERENCE TO RELATED APPLICATIONS

This application claims the benefit of Chinese Patent Application No. 201410781562.4 filed Dec. 18, 2014, the contents of which are incorporated herein by reference.

### TECHNICAL FIELD

The utility invention involves a type of automobile repair equipment, particularly the type of claws for rim installation with a tire changer.

### BACKGROUND TECHNOLOGY

With more and more automobiles in China, either imported or domestically made, it presents a great opportunity for the manufacturing of automobile repair and maintenance equipment; along with the continuing development and progress in science and technology, automobile tire rims are mostly made of aluminum alloy, which presents higher requirements for rim installation claws for the tire changer, that is they need to clamp on the tire tight while not damaging the tire.

### DETAILS OF THE UTILITY INVENTION

The purpose of this invention is to provide a rubber inlay claw for rim installation with a tire changer.

The invention is realized through the following technical plans: the dovetail boss of the rubber clamp protection pad (2) is inserted into the dovetail groove of the steel claw (1), while the two cylindrical bosses of the nylon pad (3) are situated into the two holes or bores of the steel claw (1), and the M4 countersunk screw (4) is used to fasten the nylon pad (3) to the steel claw (1); it also secures the rubber clamp protection pad (2), prevents it from sliding upward off of the steel claw (1), forming Rubber inlay claw.

How it works: four sets of boat shaped slider (5-10) mounted on the tire changer's table top are pneumatically driven, which drives and opens the rubber inlay claw to place the rims to be installed in the middle of four sets of rubber inlay claws; the four sets of boat shaped slider (5-10) are pneumatically driven, which drives the rubber inlay claws (1-4) to contract so that the rim is moves upward along the nylon pad (3) that is fixed on the steel claw (1), causing the rim clamp being placed in the angel between the rubber protection pad (2) for four sets of rubber inlay claws (see FIG. 3). The rim is clamped tight while the tire is mounted or dismounted.

Advantages of this invention include: the protection pad (2) for the rubber claw is made of rubber with high hardness. By utilizing rubber's strong adhesion properties to prevent it from sliding, it can effectively clamp and secure the aluminum rims, while preventing the contact between the aluminum rim and metal; hence, the aluminum rim is free from damage.

The protection pad (2) for the rubber claw is designed with a dovetail boss that fits into the dovetail groove of the steel claw (1). Meanwhile, the nylon pad (3) can press against the rubber claw protection pad (2), preventing it from upward sliding off of the steel claw (1). All of these ensure the stability of the rubber claw protection pad during the mounting and dismounting process.

Nylon pad (3) is made of nylon. During the rim clamping process, the rim moves along the nylon pad upwards (see FIG. 3) without contact with the metal; hence, it can effectively protect the rim against scratches by metal, while clamping the tire tight.

Rubber inlay claw (1-4) can slide on the boat shaped slider assembly (5-10). Based on the rim size, the movable pin structure and the fixed pin (9) in the boat shaped slider assembly (5-8) can be used to set gears and position. The rubber inlay claw expands the range of models and sizes of tires to be mounted and dismounted.

### BRIEF DESCRIPTION OF THE DRAWINGS

Below are detailed illustrations of the present invention along with the figures.

FIG. 1 is a schematic view of the structure of the invention.

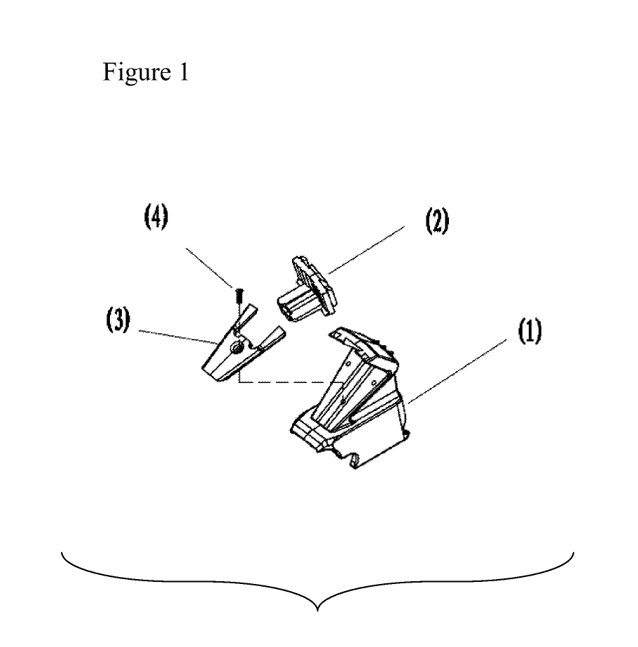

FIG. 2 is a split configuration of the invention.

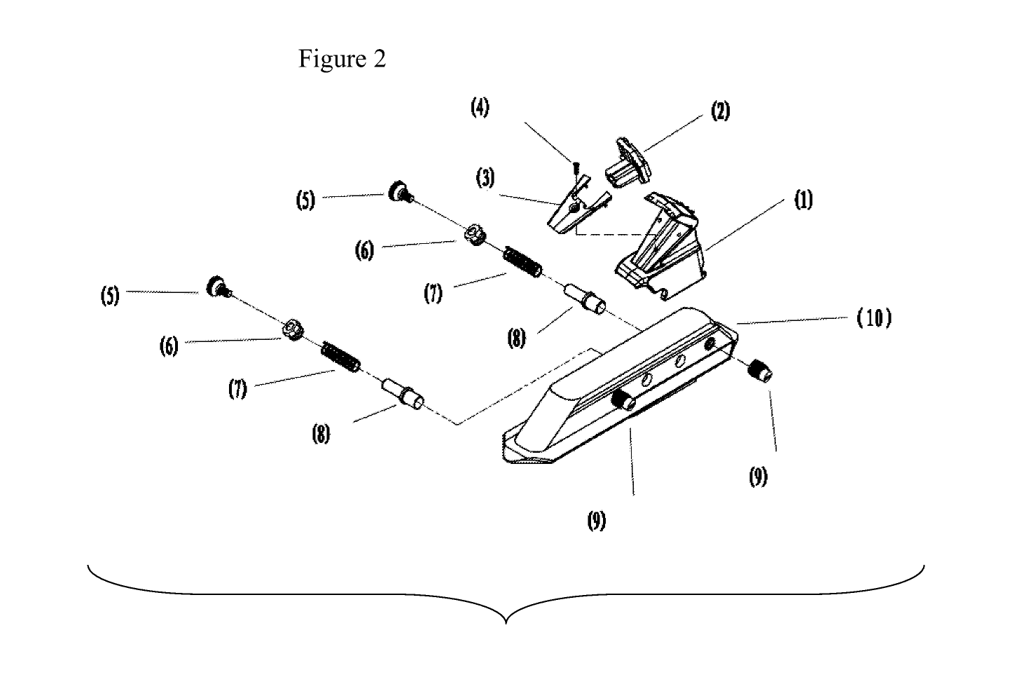

1—steel claw, 2—rubber claw protection pad, 3—nylon pad, 4—M4 countersunk screw, 5—restricting handle, 6—side cover, 7—spring, 8—movable pin, 9—fixed pin, 10—boat shaped slider.

### DETAILED DESCRIPTION

As can be seen from the figures, the clamp or claw body (1) includes an upwardly angled ramp and a stop that extends upwardly from the top of the ramp. The dovetail boss of the rubber clamp protection pad (2) is inserted into the dovetail groove of the steel claw (1), while the two cylindrical bosses of the nylon pad (3) are situated into the two holes or bores of the steel claw (1), and the M4 countersunk screw (4) is used to fasten the nylon pad (3) to the steel claw (1); it also secures the rubber clamp protection pad (2), prevents it from sliding upward off of the steel claw (1), forming the rubber inlay claw. Four sets of rubber inlay claws are installed and positioned on the four sets of boat shaped slider (5-10) that are mounted on the tire changer's table top. Based on the rim size, the movable pin structure and the fixed pin (9) in the boat shaped slider assembly (5-8) can be used to set gears and position the rubber inlay claw.

In further detail, rubber inlay claw is a type of claws for rim installation with a tire changer. It consists of four parts: steel claw base (1), rubber clamp protection pad (2), nylon pad (3) and M4 countersunk screw (4). It is characterized in that:

The dovetail boss of the rubber clamp protection pad (2) is inserted into the dovetail groove of the steel claw (1) over the front face of the claw stop, while the two cylindrical bosses of the nylon pad (3) are situated into the two holes of the steel claw (1), and the M4 countersunk screw (4) is used to fasten the nylon pad (3) to the steel claw over the top surface of the claw ramp (1); it also secures the rubber clamp protection pad (2), prevents it from sliding upward off of the steel claw (1), forming Rubber inlay claw.

The protection pad (2) for the rubber claw is made of rubber with high hardness. By utilizing rubber's strong adhesion properties to prevent it from sliding, it can effectively clamp and secure the aluminum rims, while preventing the contact between the aluminum rim and metal; hence, the aluminum rim is free from damage.

The protection pad (2) for the rubber claw is designed with a dovetail boss that fits into the dovetail groove of the steel claw (1). Meanwhile, the nylon pad (3) can press against the rubber claw protection pad (2), preventing it from upward sliding off of the steel claw (1). All of these ensure the stability of the rubber claw protection pad during the mounting and dismounting process.

Nylon pad (3) is made of nylon. During the rim clamping process, the rim moves along the nylon pad upwards (see FIG. 3) without contact with the metal; hence, it can effectively protect the rim against scratches by metal, while clamping the tire tight.

Rubber inlay claw (1-4) can slide on the boat shaped slider assembly (5-10). Based on the rim size, the movable pin structure and the fixed pin (9) in the boat shaped slider assembly (5-8) can be used to set gears and position. The rubber inlay claw expands the range of models and sizes of tires to be mounted and dismounted.

What is claimed and desired to be secured by Letters Patent is as follows:

1. A clamp for use with a rim holding tire changer, said clamp comprising:
a clamp body having an upwardly angled ramp member and a stop member extending upwardly from a top edge of said ramp member, said ramp member and said stop member presenting a claw-like clamp; and
a protective pad member secured over a top surface of said ramp member and a front surface of said stop member, to protect a tire rim from damage.

2. A clamp as in claim 1 wherein said protective pad member includes a first pad secured over said front stop surface and a portion of said top ramp surface and a second pad secured over another portion of said top ramp surface.

3. A clamp as in claim 1 further comprising means for securing said first and second pads to said clamp body.

4. A clamp as in claim 3 wherein said means for securing includes a boss member projecting downwardly from a bottom surface of said second pad member, adapted to be secured within a bore formed in said ramp member.

5. A clamp as in claim 4 wherein said means for securing includes a screw, adapted to be secured through said second pad member and into said ramp member.

6. A clamp as in claim 3 wherein said means for securing includes a second boss member projecting outwardly from a rear surface of said first pad member, adapted to be secured within a groove formed in said stop member.

7. A clamp for use with a rim holding tire changer, said clamp comprising:
a clamp body having an upwardly angled ramp member and a stop member extending upwardly from a top edge of said ramp member, said ramp member and said stop member presenting a claw-like clamp;
a first protective pad secured over a portion of a top surface of said ramp member and a front surface of said stop member, said first pad including a first boss member adapted to secure said pad to said stop member; and
a second protective pad secured over another position of said top ramp surface, said second pad including a second boss member adapted to secure said pad to said ramp member, wherein said pads protect a tire rim from damage.

8. A clamp as in claim 7 wherein said first boss member includes a dovetail boss, adapted to be secured within a dovetail groove formed in said stop member.

9. A clamp as in claim 7 wherein said second boss member includes a pair of spaced apart projections extending downwardly from said second protective pad, adapted to be secured within a bore formed in said ramp member.
